(19) United States
(12) Patent Application Publication
(10) Pub. No.: US 2005/0059159 A1
(43) Pub. Date: Mar. 17, 2005

(54) Mass spectroscopic method by electrospray ionization using salts as additives

(75) Inventor: Jung-bae Song, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co.. Ltd., Gyeonggi-do (KR)

(21) Appl. No.: 10/889,020

(22) Filed: Jul. 13, 2004

(30) Foreign Application Priority Data
Aug. 27, 2003 (KR) 10-2003-0059496

(51) Int. Cl. G01N 24/00

(52) U.S. Cl. 436/173

(57) ABSTRACT

Provided is mass spectroscopic method using electrospray ionization. The mass spectroscopic method by electrospray ionization includes analyzing an uncharged, non-basic and low polarity sample mixed with a polar solvent by using a salt as additives.

This application claims the priority of Korean Patent Application No. 2003-59496, filed on Aug. 27, 2003, in the Korean Intellectual Property Office, the disclosure of which is incorporated herein in its entirety by reference.

### BACKGROUND OF THE INVENTION

1. Field of the Invention

The present invention relates to mass spectroscopic method by electrospray ionization, and more particularly to a method of easily measuring the molecular weights of organics employing mass spectrometer using elctrospray ionization.

2. Description of the Related Art

In general, to analyze organics with a mass spectrometer, an ionization process is required. An electrospray ionization (hereinafter, refers to an ESI) method is a powerful ionization method, together with a matrix-assisted laser desorption ionization (MALDI) method, a fast atom bombardment (FAB) ionization method and the like

The ESI is initiated by pouring a solution containing samples into channels, so that an electric field at channel exits scatters the solution to fine droplets, thereby forming ionizing molecules in a gaseous state. Particularly ESI is applicable to the detection of huge biomasses while being a soft ionization method. However, it is difficult to perform ionization unless the functional groups within sample molecules to be analyzed are easily ionizing functional groups such as alcohol, amine, acid, etc. Macromolecules, 2001, 34, 3534 reports that when analyzing without adding anything to a sample, ionization is difficult and sensitivity may be too low and analysis may be difficult

In order to solve such a problem, various ionizing agents have been added to a sample. For example, weak acids and weak bases such as acetic acid, formic acid, ammonia, etc. and their salts have been employed as additives. However, where such additives are used, molecules which have bond weakly to acids and bases, for example, poly(silsesquioxane), acyl halide, etc. undergo hydrolysis only with the addition of such weak acids or weak bases, for example, formic acid or ammonium acetate, and the bonds within the molecules may be disrupted, and thus it may be difficult to apply ESI. That is, even though ESI detects molecular weights without cleaving molecules, information regarding molecules cannot always be obtained due to the reaction between the additives and the samples.

Thus, mass spectroscopic method using ESI that allows easy ionization while not reacting with samples is required.

### SUMMARY OF THE INVENTION

The present invention provides a mass spectroscopic method by electrospray ionization comprising analyzing an uncharged, non-basic and low polarity samples mixed with a polar solvent using a salt as an additive.

The uncharged, non-basic and low polarity sample according to the present invention may be one of substituted or unsubstituted C1-C20 aliphatic hydrocarbons; substituted or unsubstituted C3-C30 aromatic hydrocarbons; substituted or unsubstituted C1-C20 alkyl halides; substituted or unsubstituted C2-C20 ether-based compounds; substituted or unsubstituted C2-C20 epoxy-based compounds; substituted or unsubstituted C1-C20 sulfide-based compounds; substituted or unsubstituted C2-C20 nitrile-based compounds; substituted or unsubstituted C1-C20 aldehyde-based compounds; substituted or unsubstituted C1-C20 ester compounds; substituted or unsubstituted C2-C20 enol-based compounds; substituted or unsubstituted C2-C20 enolate-based compounds; substituted or unsubstituted C2-C20 enamine-based compounds; substituted or unsubstituted C1-C20 amide-based compounds; substituted or unsubstituted C1-C20 imide-based compounds; substituted or unsubstituted C4-C20 dioxane-based compounds; substituted or unsubstituted C4-C20 thiophene-based compounds; substituted or unsubstituted C1-C20 amine-based compounds; substituted or unsubstituted C1-C20 nitro compounds; substituted or unsubstituted C2-C20 ketone compounds; substituted or unsubstituted C1-C20 silane-based compounds; and mixtures of two or more thereof.

The salts may be one of alkali metals such as Li, Na, K, Rb, Cs, Fr, etc. and transition metals such as Fe, Cu, Ni, Zn, Co, Ag, etc., as cations; and halogen ions such as F, Cl, Br, I, etc. and acetate derivatives such as acetate, monochloroacetate, trifluoroacetate, etc., as anions.

The polar solvents may be one of a polar aprotic solvent or a polar protic solvent, and examples thereof include acetonitrile, methanol, ethanol, propanol, chloroform, dichloromethane, tetrahydrofuran (THF), dimethyl formamide (DMF), dimethyl sulfoxide (DMSO), dioxane, N-methyl-2-pyrrolidone (NMP), water or mixtures of two or more thereof.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating electrospray ionization according to an embodiment of the present invention;

FIG. 2 is a spectrum of mass spectroscopic method of Example 1;

FIG. 3 is a spectrum of mass spectroscopic method of Comparative Example 1;

FIG. 4 is a spectrum of mass spectroscopic method of Example 2;

FIG. 5 is a spectrum of mass spectroscopic method of Comparative Example 2;

FIG. 6 is a spectrum of mass spectroscopic method of Example 3;

FIG. 7 is a spectrum of mass spectroscopic method of Comparative Example 3;

FIG. 8 is a spectrum of mass spectroscopic method of Example 4;

FIG. 9 is a spectrum of mass spectroscopic method of Example 5;

FIG. 10 is a spectrum of mass spectroscopic method of Example 6;

FIG. 11 is a spectrum of mass spectroscopic method of Example 7;

FIG. 12 is a spectrum of mass spectroscopic method of Example 8;

FIG. 13 is a spectrum of mass spectroscopic method of Example 9;

FIG. 14 is a spectrum of mass spectroscopic method of Comparative Example 4;

FIG. 15 is a spectrum of mass spectroscopic method of Comparative Example 5; and

FIG. 16 is a spectrum of mass spectroscopic method of Comparative Example 6.

### DETAILED DESCRIPTION OF THE INVENTION

The present invention will be described in more detail by describing embodiments thereof.

For the mass spectroscopic method by electrospray ionization according to an embodiment of the present invention, a minute amount of salts is added to the solution in which the samples to be analysed are dissolved to enhance the sensitivity of measurements, and desired analysis of samples is more easily performed by decreasing the interference of degradation products or by-products. Particularly, the state of mixtures can be observed in details by generating only a molecular peak or a similar peak in a spectrum of mass spectroscopic method.

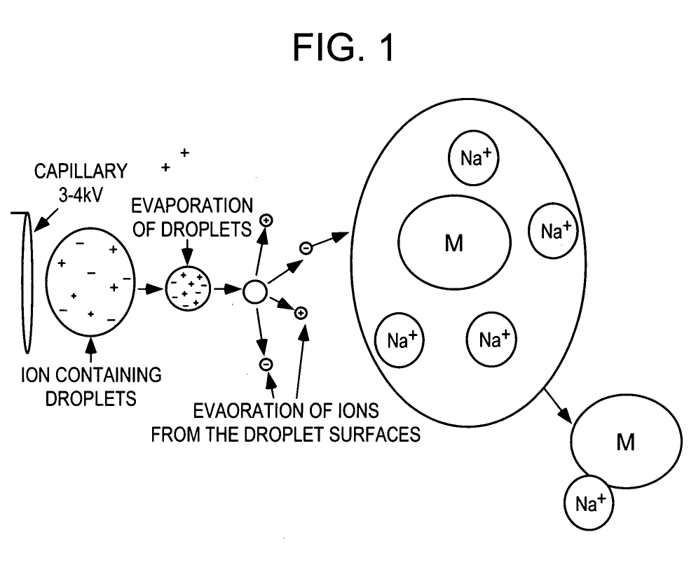

In the mass spectroscopic method by electrospray ionisation according to an embodiment of the present invention, uncharged, non-basic and low polarity samples are analysed in polar solvents using salts as additives. By using salts as additives, as illustrated in FIG. 1, when droplets of ion containing samples which are passed through columns are sprayed in an electric field, the salt ions surrounds the samples evaporated from the sample droplets to form an adduct of the samples and the salts, thereby allowing the samples to be charged. Such charged sample molecules are detected in a detector, thereby representing molecular peaks or similar molecular peaks in the spectrums of mass spectroscopic method.

Thus, even if molecules that bind weakly to acids or bases such as polysilsesquioxanes or acyl halides are used as samples, the bonding is not disrupted due to the reaction, for example, hydrolysis, etc. of the additives with the samples to be measured, so the molecular weights can be detected, and thus, the interference of the degradation products and by-products can be decreased and the sensitivity of measurement can be improved.

Particularly, the method of predicting initial film quality and stability of precursors before applying a silicon compound as a low dielectric film material to a process was not present. However, if the mass spectroscopic method according to an embodiment of the present invention is used, the analysis of composition of precursors is possible. Thus, the stability against time lapses since the preparation of precursors can be verified early, and also the sensitivity of measurement is improved so that the amounts of samples needed for analysis may be at most a few μg.

Furthermore, although the prior art mass spectroscopic method by electrospray ionization is mainly used in samples containing the functional groups facilitating ionization of alcohol, amine, acid, etc., the mass spectroscopic method according to an embodiment of the present invention can be used to easily achieve ionization, even at a sample not containing functional groups within the molecules, and the mass spectroscopic method by electrospray ionization can be possible, and thus, the restriction of samples is decreased.

The samples that can be analyzed using the mass spectroscopic method according to an embodiment of the present invention are not restricted as long as they are uncharged, non-basic and have low polarity, and may be, for example, substituted or unsubstituted C1-C20 aliphatic hydrocarbons; substituted or unsubstituted C3-C30 aromatic hydrocarbons; substituted or unsubstituted C1-C20 alkyl halides; substituted or unsubstituted C2-C20 ether-based compounds; substituted or unsubstituted C2-C20 epoxy-based compounds; substituted or unsubstituted C1-C20 sulfide-based compounds; substituted or unsubstituted C2-C20 nitrile-based compounds; substituted or unsubstituted C1-C20 aldehyde-based compounds; substituted or unsubstituted C1-C20 ester compounds; substituted or unsubstituted C2-C20 enol-based compounds; substituted or unsubstituted C2-C20 enolate-based compounds; substituted or unsubstituted C2-C20 enamine-based compounds; substituted or unsubstituted C1-C20 amide-based compounds; substituted or unsubstituted C1-C20 imide-based compounds; substituted or unsubstituted C4-C20 dioxane-based compounds; substituted or unsubstituted C4-C20 thiophene-based compounds; substituted or unsubstituted C1-C20 amine-based compounds; substituted or unsubstituted C1-C20 nitro compounds; substituted or unsubstituted C2-C20 ketone compounds; or substituted or unsubstituted C1-C20 silane-based compounds; and the like.

Examples of the ester-based compounds include carboxylate-based compounds, phthalate-based compounds, acid anhydrides, phosphate-based compounds, sulfate-based compounds, waxes, lipids, etc.

Examples of the aliphatic compounds include cholestryl, cycloalkane, steroid, etc.

Examples of the cycloalkane include cyclopentane, cyclohexane, etc.

Examples of the aromatic hydrocarbon include benzene, anthracene, etc.

Examples of the silane-based compounds include aminosilane, silylacetamide, silylimidazol, alkoxysilane, siloxane, silylhalide, etc.

Examples of the ketone-based compounds include fluorenone, anthraquinone, naphthoquinone, thiophenoquinone, etc.

The samples are dissolved or dispersed in proper polar solvents, and their concentrations are preferably in the range of 10⁻⁶M to 0.01M. If the concentrations of the samples exceed 0.01M, the source can become contaminated and the degradation ability of a molecular peak is decreased; if the concentrations are less than 10⁻⁶M, the sensitivity of measurements is decreased.

General polar solvents can be used and examples thereof include polar aprotic solvents and polar protic solvents, etc. Specific examples of polar solvents include acetonitrile, methanol, ethanol, propanol, chloroform, dichloromethane, tetrahydrofuran (THF), dimethylformamide (DMF), dimethylsulfoxide (DMSO), dioxane, N-methyl-2-pyrrolidone (NMP), water and mixtures of two or more thereof.

The salts used as additives may be alkali metals such as Li, Na, K, Rb, Cs, Fr, etc. and transition metals such as Fe, Cu, Ni, Zn, Co, Ag, etc., as cations; and halogen ions such as F, Cl, Br, I, etc. and compounds comprising acetate derivatives such as acetate, monochloroacetate, trifluoroacetate, etc., as anions. The salts may be Nal or Csl, which are very soluble in anionic monovalent organic solvents. Such salts are added in minute amounts to solutions in which samples are dissolved before analyzing.

The salts can be added in concentrations of 10⁻⁶ to 10⁻² M in the solution in which samples are dissolved. If the amounts of added salts are less than 10⁻⁶M, the ionization may become insufficient; if the amounts exceed 10⁻²M, a peak may be caused by salt itself and the source may be contaminated.

When analyzing samples with use of the salts as additives in polar solvents, the cleavage of molecules occurs so rarely that there is little interference caused by degradation products or by-products and the mass spectrum in which only peaks of a molecule itself or a similar molecule (e.g., M, M+Na, M+K, etc.) are present is obtained. Thus, initial film quality and stability of precursors before applying a silicon compound as a low dielectric film material to a process can be predicted early and correctly. The mass spectroscopic method according to the present invention is also useful in the analysis of plastics in gaskets used in refrigerators, which have not been analyzed by general mass spectrometry due to the cleavage of molecules in GC/MS, and the molecular weights of waxes which cannot be GC analyzed due to low volatility can be measured

The present invention will be described in greater detail with reference to the following examples. The following examples are for illustrative purposes and are not intended to limit the scope of the invention.

### EXAMPLES

The following parameters were used in the mass spectrometer using electrospray ionization of the following examples:

a) Cone voltage: 10 to 120V

b) Capillary voltage: 1 to 5 kV

c) Source temperature: 50 to 200° C.

d) Desolvation temperature: 100 to 300° C.

### Example 1

2.8 mg of the compound represented by Formula I below was added as a sample to 1 g of methanol, a polar solvent. The resulting solution was diluted in methanol at a ratio of 1:400.0.001M of NaI as an additive was added to the solution, and then the solution was analyzed. The solution was used as a sample under the conditions of 76V cone voltage, a 3.01 kV capillary voltage, a 150° C. source temperature, a 250° C. desolvation temperature, and a 10 ul/min infusion rate.

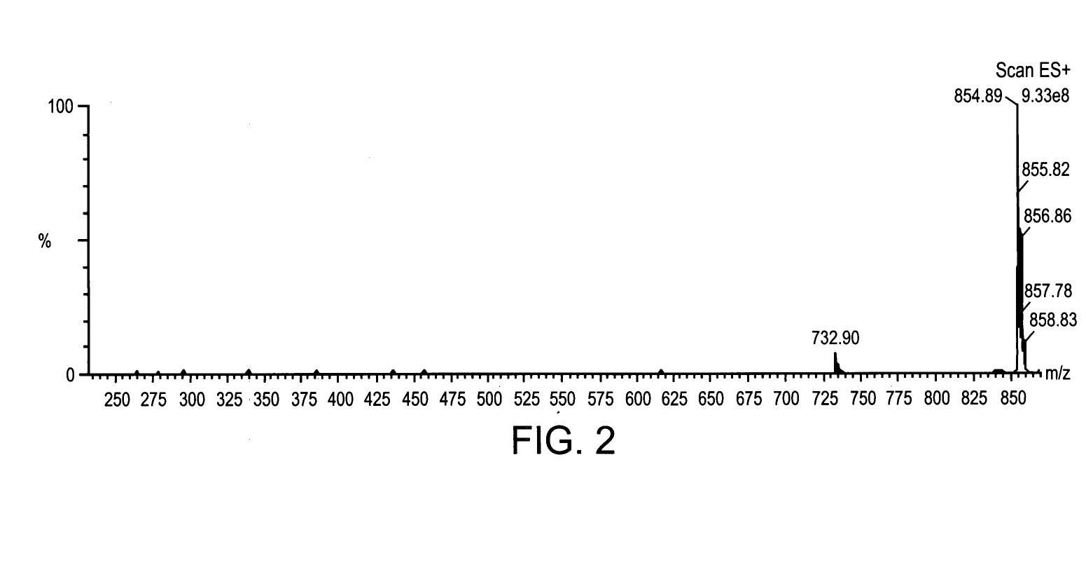

The results are illustrated in FIG. 2, which shows that peaks before and after 856 corresponding to M+Na appear and an unknown peak or the peak of molecular fractions little appears.

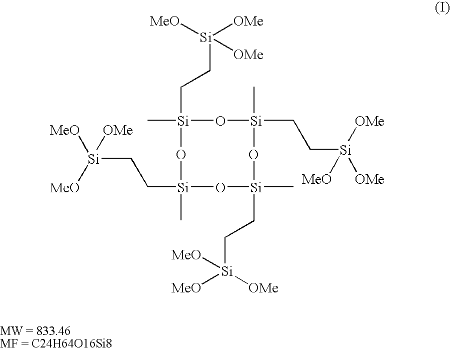

### Comparative Example 1

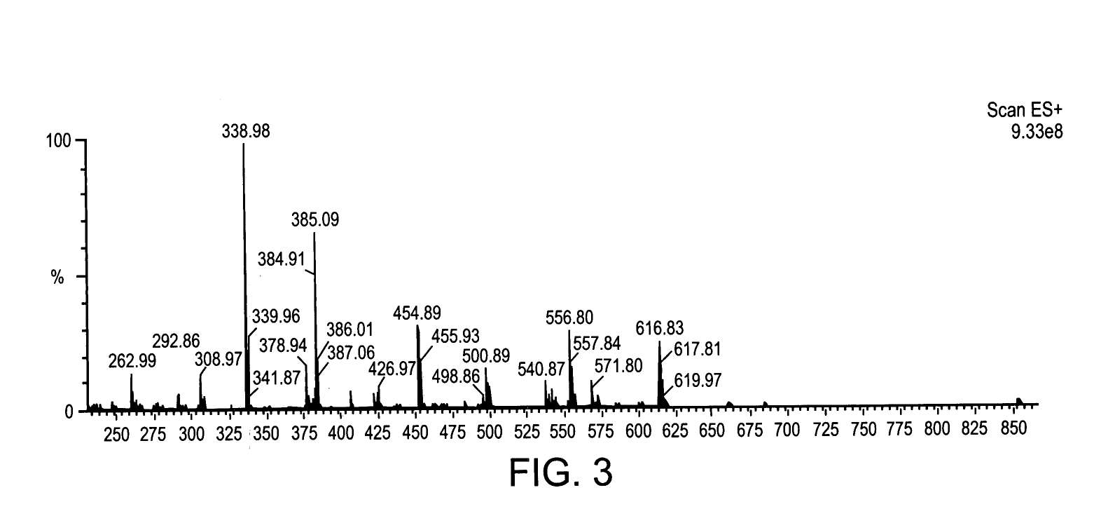

The process was carried out in the same way as in Example 1 except that NH₄Ac was used instead of NaI as an additive, and the resulting spectrum is shown in FIG. 3. From the spectrum of FIG. 3, it can be seen that in molecules of the sample, hydrolysis occurred and thus the molecular peak or the peak of similar molecules did not appear but only products of the hydrolysis products were produced in large quantities.

### Example 2

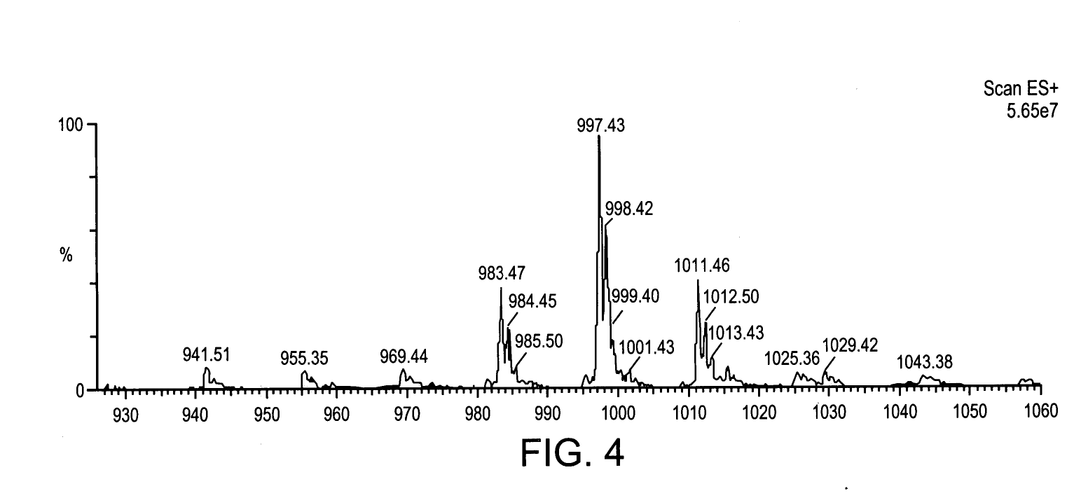

The process was carried out in the same way as in Example 1 (using NaI as additive) except that wax components used in refrigerator gaskets were used instead of the compound of Formula I, and the resulting spectrum is shown in FIG. 4. From the spectrum of FIG. 4, it can be seen that the peaks of the degradation products and the by-products were significantly reduced and the sensitivity of measurement was increased up to 400 times compared to Comparative Example 2.

### Comparative Example 2

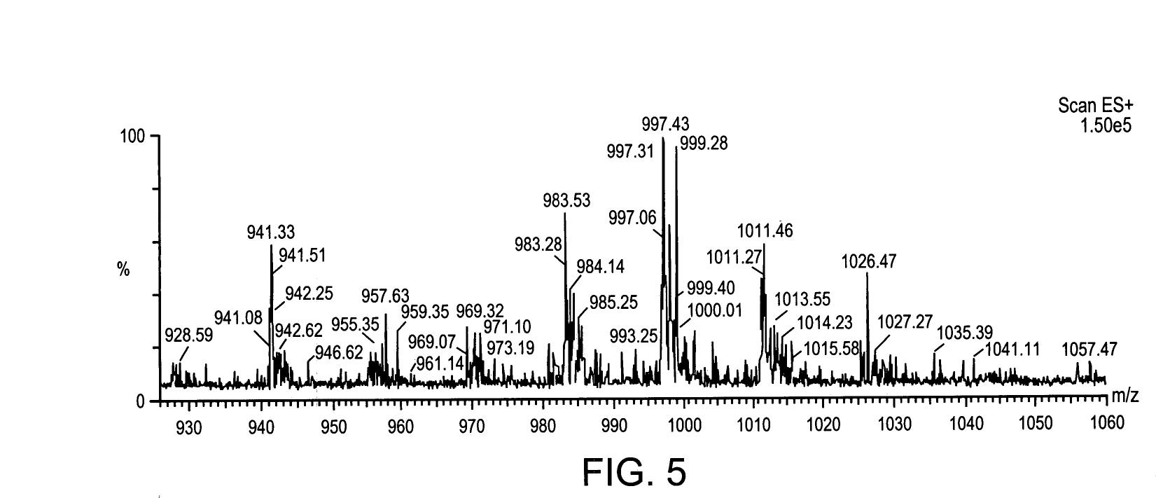

The process was carried out in the same way as in Example 2 except that NaI was not used as an additive, and the resulting spectrum is shown in FIG. 5. From the spectrum of FIG. 5, it can be seen that the peaks of the degradation products and the by-products appeared in large quantities and the sensitivity of measurement was significantly reduced.

### Example 3

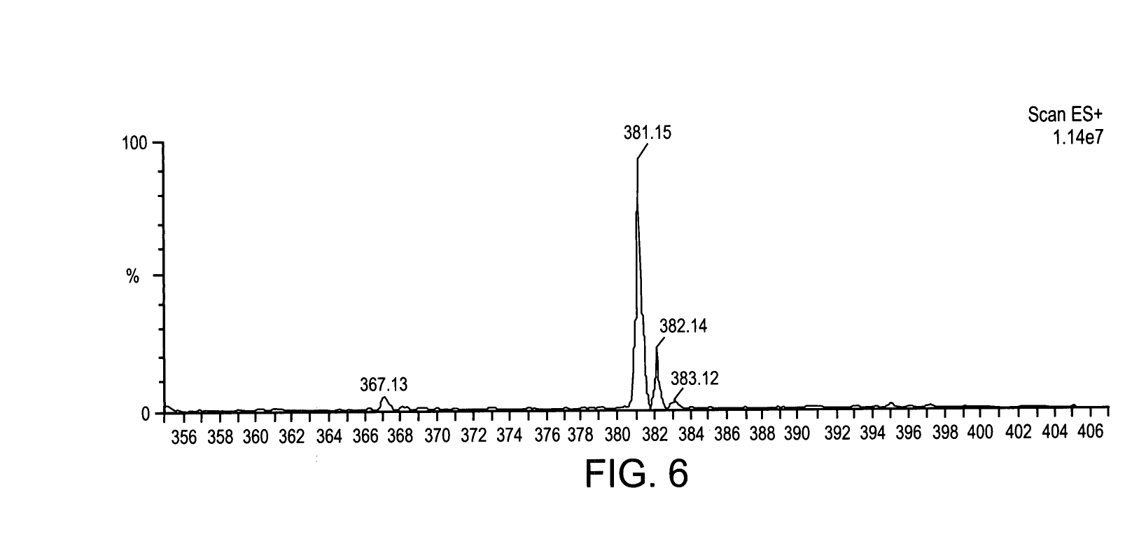

The process was carried out in the same way as in Example 1 except that the compound represented by II below, a liquid crystal molecule used in LCD was used instead of the compound of Formula I, and the resulting spectrum is shown in FIG. 6. From the spectrum of FIG. 6, it can be seen that the sensitivity of measurement was increased about 30 times and the S/N ratio was higher than the following Comparative Example 3 carried out without additives.

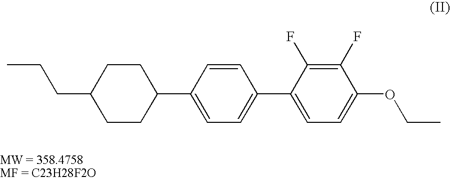

### Comparative Example 3

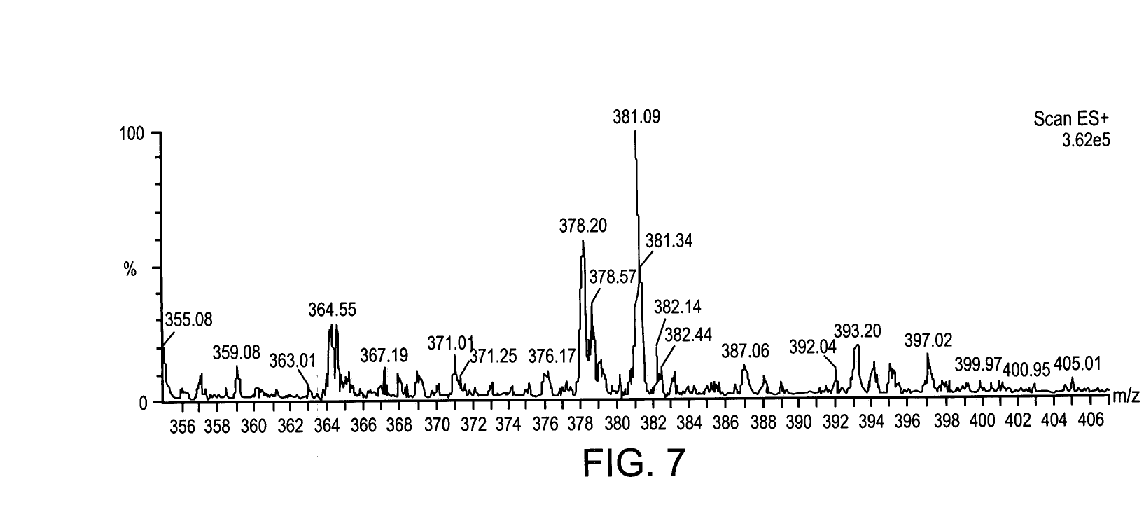

The process was carried out in the same way as in Example 3 except that no additives were used, and the resulting spectrum is shown in FIG. 7. From the spectrum of FIG. 7, it can be seen that the peaks of the degradation products and the by-products appeared in large quantities and the sensitivity of measurement was significantly reduced.

### Example 4

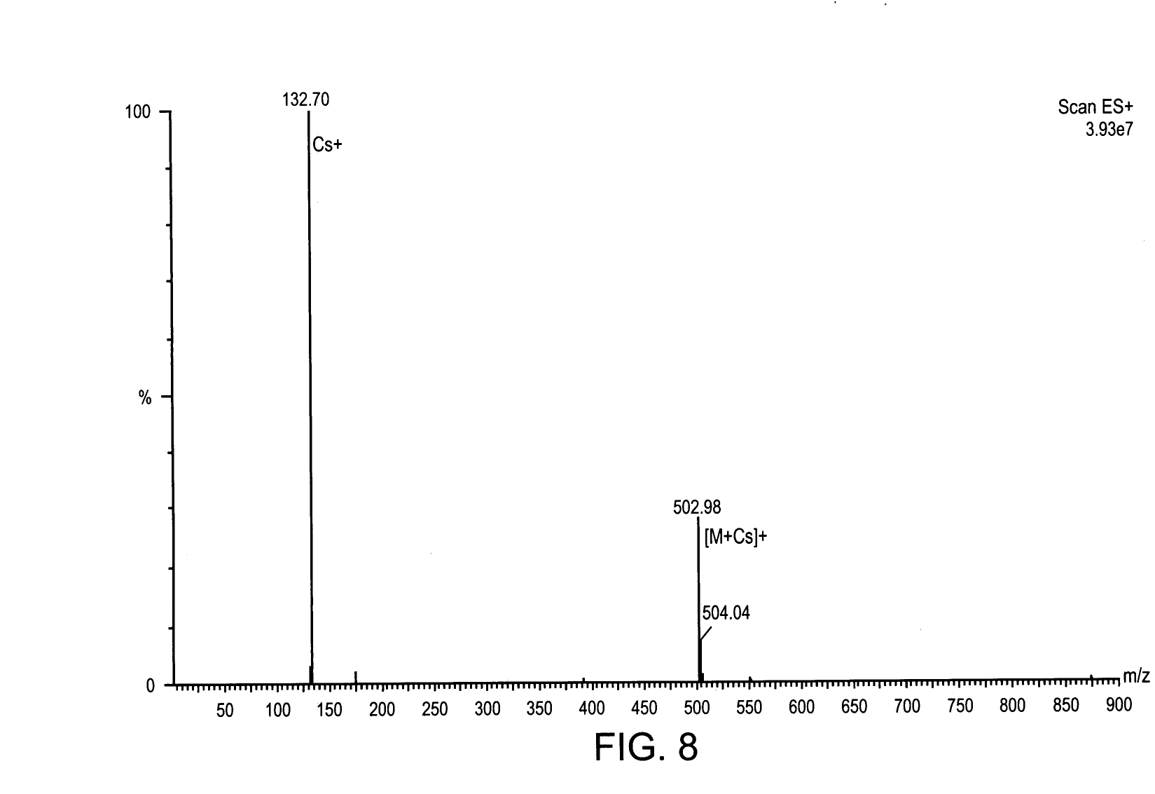

The process was carried out in the same way as in Example 1 except that the compound represented by Formula III below was used instead of the compound of Formula I and CsI was used as an additive instead of NaI, and the resulting spectrum is shown in FIG. 8. From the spectrum of FIG. 8, it can be seen that the peak of similar molecules, i.e., peak of [M+Cs]⁺, appeared without unknown peaks or the peaks of the by-products or the degradation products.

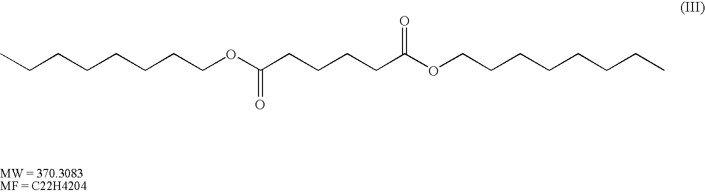

### Example 5

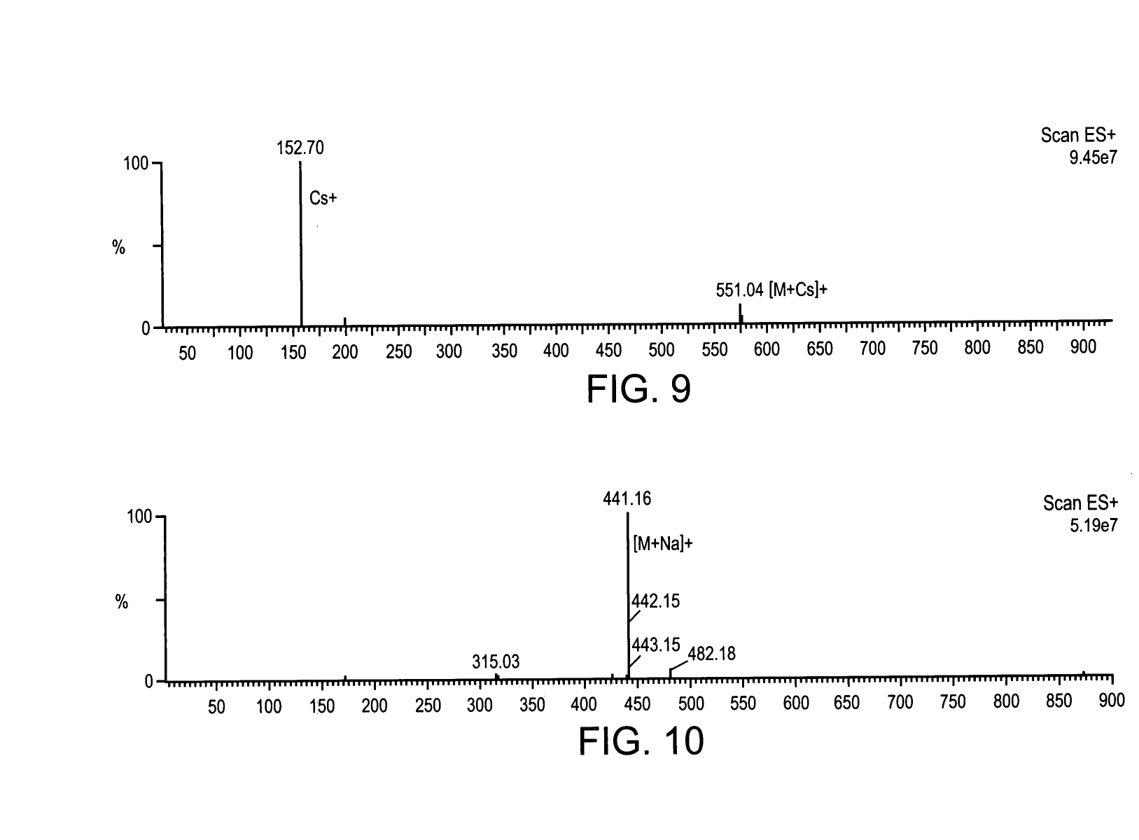

The process was carried out in the same way as in Example 1 except that the compound represented by Formula IV below was used instead of the compound of Formula I and CsI was used as an additive instead of NaI, and the resulting spectrum is shown in FIG. 9. From the spectrum of FIG. 9, it can be seen that the peak of similar molecules, i.e., peak of [M+Cs]⁺, appeared without unknown peaks or the peaks of the by-products or the degradation products.

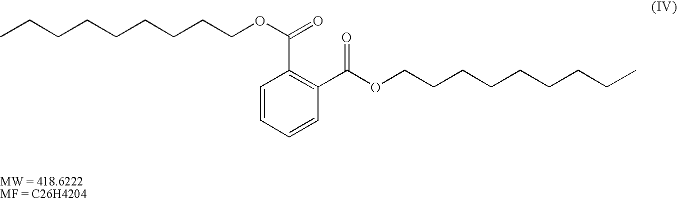

### Example 6

The process was carried out in the same way as in above Example 5 except that NaI was used instead of CsI, and the resulting spectrum is shown in FIG. 10. From the spectrum of FIG. 10, it can be seen that the peak of similar molecules, i.e., peak of [M+Cs]⁺, was obtained.

### Example 7

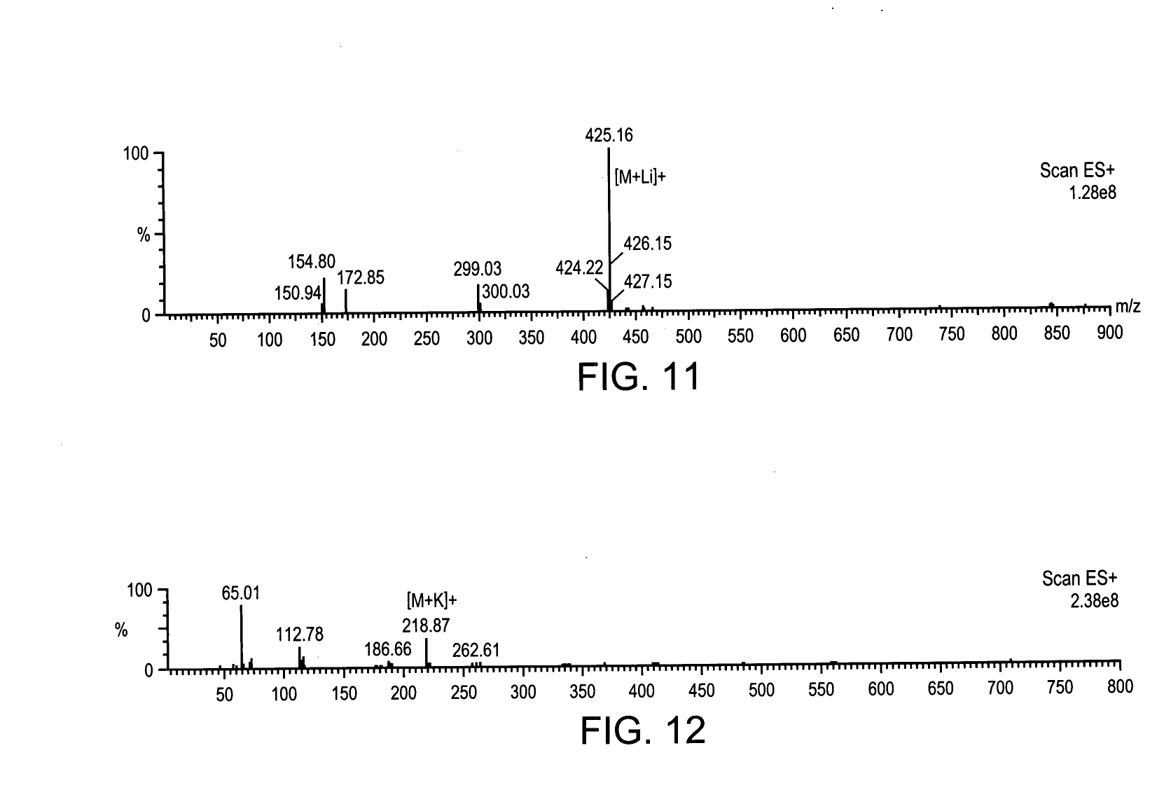

The process was carried out in the same way as in Example 5 except that LiOTf (lithium trifluoromethanesulfonate) was used instead of CsI, and the resulting spectrum is shown in FIG. 11. From the spectrum of FIG. 11, it can be seen that the peak of similar molecules, i.e., peak of [M+Li]⁺, was obtained.

### Example 8

The process was carried out in the same way as in Example 1 except that glucose was used instead of the compound of Formula I and KCl was used as an additive instead of NaI, and the resulting spectrum is shown in FIG. 12. From the spectrum of FIG. 12, it can be seen that the peak of similar molecules, i.e., peak of [M+K]⁺, appeared at 218.87.

### Example 9

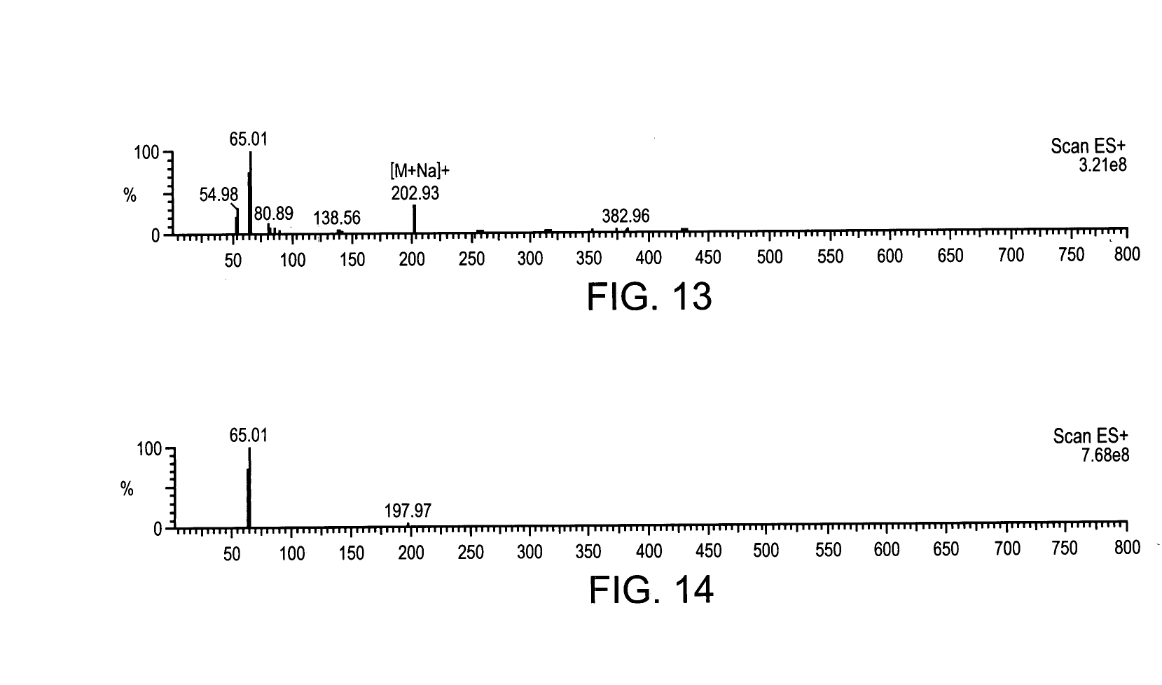

The process was carried out in the same way as in Example 8 except that NaCl was used as an additive instead of KCl, and the resulting spectrum is shown in FIG. 13. From the spectrum of FIG. 13, it can be seen that the peak of similar molecules, i.e., peak of [M+Na]⁺, appeared at 202.93.

### Comparative Example 4

The process was carried out in the same way as in Example 8 except that HCOOH was used as an additive instead of KCl, and the resulting spectrum is shown in FIG. 14. From the spectrum of FIG. 14, it can be seen that the peak of similar molecules did not appear.

### Comparative Example 5

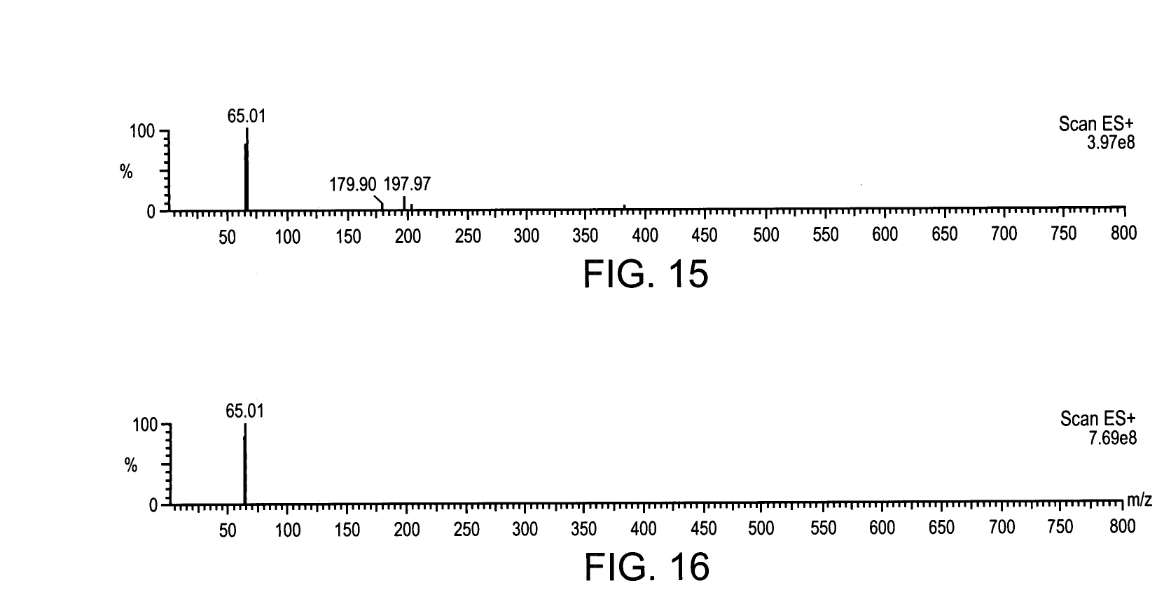

The process was carried out in the same way as in Example 8 except that NH₃ was used as an additive instead of KCl, and the resulting spectrum is shown in FIG. 15. From the spectrum of FIG. 15, it can be seen that the peak of similar molecules did not appear.

### Comparative Example 6

The process was carried out in the same way as in Example 8 except that no additives were used, and the resulting spectrum is shown in FIG. 16. From the spectrum of FIG. 16, it can be seen that the peak of similar molecules did not appear.

According to embodiments of the present invention, the analysis of composition of precursors in a mixed state is possible so that, for example, initial film quality and stability of precursors before applying a silicon compound as a low dielectric film material to a process can be predicted, and the sensitivity of measurement is improved so that the amounts of samples needed for analysis can be at most a few μg, and also molecular weights can be measurable even at a sample not containing functional groups within the molecule.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A mass spectroscopic method by electrospray ionization comprising analyzing an uncharged, non-basic and low polarity samples mixed in a polar solvent by using a salt as an additive.

2. The mass spectroscopic method by electrospray ionization of claim 1, wherein the uncharged, non-basic and low polarity sample is one selected from the group consisting of substituted or unsubstituted C1-C20 aliphatic hydrocarbons; substituted or unsubstituted C3-C30 aromatic hydrocarbons; substituted or unsubstituted C1-C20 alkyl halides; substituted or unsubstituted C2-C20 ether-based compounds; substituted or unsubstituted C2-C20 epoxy-based compounds; substituted or unsubstituted C1-C20 sulfide-based compounds; substituted or unsubstituted C2-C20 nitrile-based compounds; substituted or unsubstituted C1-C20 aldehyde-based compounds; substituted or unsubstituted C1-C20 ester compounds; substituted or unsubstituted C2-C20 enol-based compounds; substituted or unsubstituted C2-C20 enolate-based compounds; substituted or unsubstituted C2-C20 enamine-based compounds; substituted or unsubstituted C1-C20 amide-based compounds; substituted or unsubstituted C1-C20 imide-based compounds; substituted or unsubstituted C4-C20 dioxane-based compounds; substituted or unsubstituted C4-C20 thiophene-based compounds; substituted or unsubstituted C1-C20 amine-based compounds; substituted or unsubstituted C1-C20 nitro compounds; substituted or unsubstituted C2-C20 ketone compounds; substituted or unsubstituted C1-C20 silane-based compounds; and mixtures of two or more thereof.

3. The mass spectroscopic method by electrospray ionization of claim 2, wherein the aliphatic compounds are cholestryl, cycloalkane and steroid.

4. The mass spectroscopic method by electrospray ionization of claim 2, wherein the aromatic hydrocarbons are benzene or anthracene.

5. The mass spectroscopic method by electrospray ionization of claim 2, wherein the silane-based compounds are aminosilane, silylacetamide, silylimidazol, alkoxysilane, siloxane and silylhalide.

6. The mass spectroscopic method by electrospray ionization of claim 2, wherein the ketone-based compounds are fluorenone, anthraquinone, naphthoquinone and thiophenoquinone.

7. The mass spectroscopic method by electrospray ionization of claim 1, wherein the salt is one selected from the group consisting of alkali metals and transition metals as cations, and halogen ions and acetate derivatives as anions.

8. The mass spectroscopic method by electrospray ionization of claim 1, wherein the salt is NaI or CsI.

9. The mass spectroscopic method by electrospray ionization of claim 1, wherein the concentration of the salts is in the range of 10⁻⁶M to 10⁻²M.

10. The mass spectroscopic method by electrospray ionization of claim 1, wherein the polar solvent is one selected from the group consisting of acetonitrile, methanol, ethanol, propanol, chloroform, dichloromethane, tetrahydrofuran (THF), dimethylformamide (DMF), dimethylsulfoxide (DMSO), dioxane, N-methyl-2-pyrrolidone (NMP), water and mixtures of two or more thereof.
